(19) United States
(12) Patent Application Publication
(10) Pub. No.: US 2009/0211125 A1
(43) Pub. Date: Aug. 27, 2009

(54) BADGE ASSEMBLY

(76) Inventor: Randy Cremer, San Diego, CA (US)

Correspondence Address: NovaTech IP Law, 1001 Avenue Pico, Suite C500, San Clemente, CA, 92673, US

(21) Appl. No.: 12/244,657

(22) Filed: Oct. 2, 2008

Related U.S. Application Data
(60) Provisional application No. 61/031,425, filed on Feb. 26, 2008.

(51) Int. Cl. A44C 3/00; B42D 1/00

(52) U.S. Cl. 40/1.5; 281/38

(57) ABSTRACT

Provided is a notepad assembly comprising a rigid backing and at least one sheet layer which is configured to be connectable to a badge member which may be formed as an employee identification badge. The sheet layers are preferably formed as a stack of sheet layers attachable to the rigid backing and which may be sandwiched between the rigid backing and the badge member. A connecting device such as a strap may be threaded through openings formed in the badge member and the rigid backing to allow pivoting of the badge member to expose the sheet layer such that a user may record notes thereon.

### CROSS-REFERENCE TO RELATED APPLICATIONS

The present application claims priority to co-pending U.S. Provisional Application No. 61/031,425 entitled IDENTIFICATION BADGE NOTEPAD filed on Feb. 26, 2008, the entire contents of which is expressly incorporated by reference herein

### STATEMENT RE: FEDERALLY SPONSORED RESEARCH/DEVELOPMENT

(Not Applicable)

### FIELD

The present invention relates generally to notepads and, more particularly, to a uniquely-configured notepad assembly specifically adapted for attachment to a badge member such as an employee identification badge.

### BACKGROUND

It is common during the personal and professional lives of many people to make handwritten notes of various types of information such as names, phone numbers and addresses including work-related information. Unless a notebook is carried specifically for the purpose of taking such notes, when presented with a situation where it is necessary to record information, it is a common practice for individuals to use the nearest available scrap of paper or other object for taking notes. Such objects may include napkins, envelopes and paper currency.

In the case of professionals such as engineers, it is common to interface with a variety of different people in various locations far from the engineer's work location. For example, it is common practice for engineers to coordinate with manufacturing technicians in order to resolve issues that may arise during the design, development, manufacturing and testing phases of software and hardware.

Apart from committing the information to memory, in order to record information, the engineer must search for scraps of paper or carry a notebook specifically for the purpose of taking notes. Unfortunately, the requirement to carry a separate notebook is inconvenient due to the bulk, size and weight of conventional notebooks. Furthermore, the carrying of a separate notebook is, in many cases, impractical if the need to take notes arises infrequently or sporadically. A further drawback associated with taking notes on scraps of paper is the risk that the scraps may become lost or forgotten. Another risk associated with recording information on scraps of paper is that, over time, the notes may become faint or illegible when carried in the user's pockets.

As can be seen, there exists a need in the art for a self-contained note-taking apparatus which is small in size, light in weight and which may be easily attachable to an article or object which may be worn by an individual and which obviates the need to carry a separate notebook.

### BRIEF SUMMARY

The above-described needs associated with note-taking are specifically addressed and alleviated by the various embodiments of a notepad assembly as described herein and wherein the notepad assembly may be conveniently carried by attachment to an object such as a badge member such as an employee identification badge. The badge member may be formed as a rigid or semi-rigid member although the badge member may be a flexible member. The badge member may include a variety of indicia and/or markings formed thereon such as an employee identification number, company information and/or images of an employee.

The notepad assembly may comprise a rigid backing and may include one or more sheet layers which are preferably formed as a plurality of sheet layers arranged in stacked formation. The rigid backing is preferably attachable to the badge member and is preferably pivotally connectable thereto to allow hinging of the badge member upwardly away to expose the sheet layers such that a user may record information thereupon. The rigid backing is preferably provided as a stiff and stable member against which the sheet layers may be attached to allow a user to record handwritten notes without bending, folding or bowing of the sheet layers.

The sheet layers are preferably attachable to the rigid backing although they may be attachable to the badge member. The sheet layers are preferably arranged in stacked formation and are preferably sandwiched between the rigid backing and the badge member. As was earlier mentioned, each of the sheet layers is preferably adapted for receiving notes thereupon such as handwritten notes and/or printed notes and for receiving information or memorandum as well as for attaching other objects thereto such as stickers, labels, pens, photos and other information for later referral. It should also be noted that the notepad assembly may be provided as a separate component apart from the badge assembly. In this regard, the notepad assembly may comprise the rigid backing and one or more sheet layers preferably formed as a plurality of sheet layers. The notepad assembly may be adapted for attachment to a variety of articles including, without limitation, worn articles such as a belt or a shirt pocket, articles that may be carried and/or non-movable articles or objects. Even further, the notepad assembly may be adapted for use as a standalone apparatus for use without attachment to any article or object.

In one embodiment, the sheet layers are releasably-adhered to one another similar to commercially available self-adhesive notepads. However, it is also contemplated that the sheet layers may be permanently secured to the rigid backing. Each of the sheet layers may include a separation joint which may be formed as a perforation line extending along an upper edge of the sheet layers such that a removable portion of each sheet layer may be separated from a fixed portion of the sheet layer which may remain attached to the rigid backing.

The badge assembly may further include a connecting device such as a strap or lanyard to connect the rigid backing and/or sheet layers to the badge member. The connecting device is preferably configured to allow the rigid backing or the badge member to be pivoted away from the sheet layers to at least partially expose an uppermost one of the sheet layers such that notes may be formed thereon. The rigid backing, badge member and sheet layer are preferably, but optionally, formed complementary to one another. In this regard, the rigid backing, badge member and sheet layer are preferably similar in size and shape although dissimilar shapes and sizes are contemplated. Furthermore, the rigid backing, badge member and sheet layer may be aligned with one another when connected together although they may be arranged to be misaligned when connected together.

To facilitate attachment of the rigid backing and badge member, an opening may be formed in each of the rigid backing and badge members. The opening may comprise a slot through which a flexible strap may be threaded to form a hinge to allow pivoting of the badge member away from the notepad assembly. In this manner, the badge assembly allows a user to record notes in spur-of-the-moment situations or allow the user to pass along information to others in a quick and efficient manner without the need to carry a bulky, heavy notepad.

The features, functions and advantages that have been discussed can be achieved independently in various embodiments of the present disclosure or may be combined in yet other embodiments, further details of which can be seen with reference to the following description and drawings below.

### BRIEF DESCRIPTION OF THE DRAWINGS

These and other features of the present invention will become more apparent upon reference to the drawings wherein like numbers refer to like parts throughout and wherein:

FIG. 1 is a perspective illustration of a badge assembly having a notepad assembly and a badge member shown partially pivoted away from the notepad assembly to expose a sheet layer of the notepad assembly;

FIG. 2 is a perspective illustration of the notepad assembly comprising the sheet layer disposed and a rigid backing;

FIG. 3 is a plan view of the notepad assembly;

FIG. 4 is a side view of the notepad assembly;

FIG. 5 is a cross-sectional illustration of the notepad assembly taken along lines 5-5 of FIG. 3;

FIG. 6 is a view looking at an underside of the notepad assembly and illustrating the rigid backing; and

FIG. 7 is a perspective illustration of the notepad assembly in a further embodiment.

### DETAILED DESCRIPTION

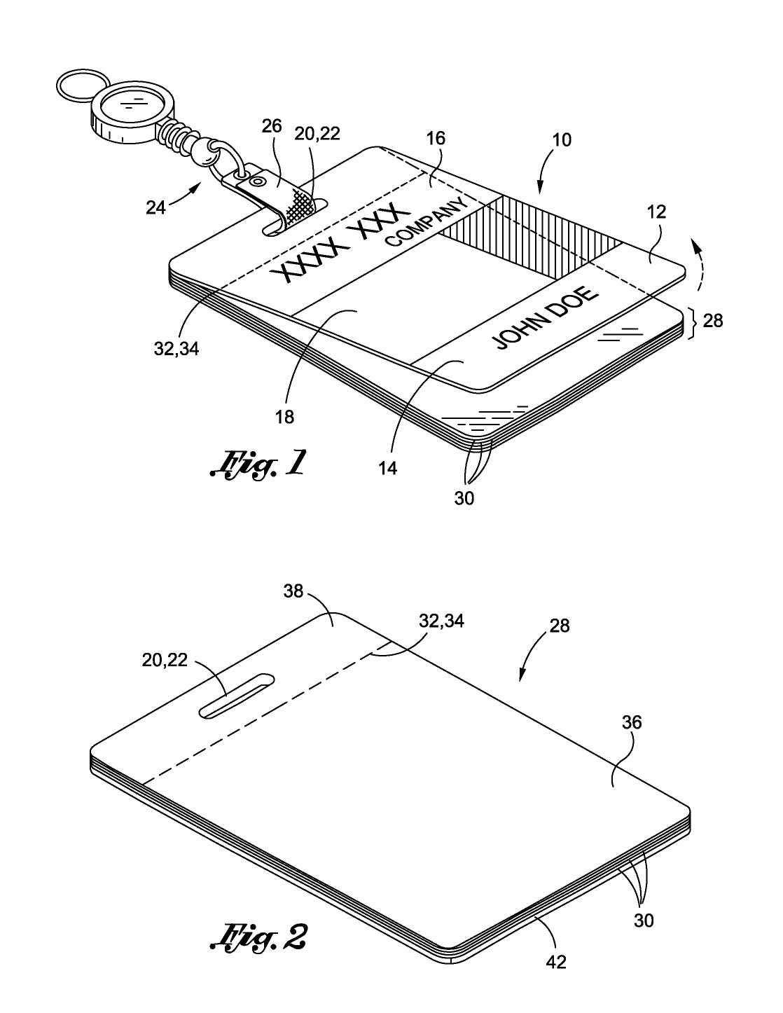

Referring now to the drawings wherein the showings are for purposes of illustrating various embodiments of the disclosure only and not for purposes of limiting the disclosed embodiments, shown in FIG. 1 is a perspective illustration of a badge assembly 10 which, in a broad sense, comprises a notepad assembly 28 that may be attachable to a badge member 12. The badge member 12, in one embodiment, may be configured as an employee identification badge. The notepad assembly 28 may comprise a rigid backing 42 having at least one and, more preferably, a plurality of sheet layers 30 attachable thereto. The sheet layers 30 may be configured to be removable or the sheet layers 30 may be configured to remain attached to the notepad assembly 28 and/or to other sheet layers 30. Advantageously, the rigid backing 42 and/or the plurality of sheet layers 30 may be removably attached to the badge member 12. The notepad assembly 28 facilitates the recording of notes and other information on the sheet layers 30 by flipping the badge member 12 upwardly to expose the sheet layer 30.

The rigid backing 42 provides a measure of protection for the sheet layers 30 by preventing damage thereto such as may otherwise occur as a result of bending or folding of the sheet layers 30. Furthermore, the rigid backing 42 provides a stable and stiff member against which the user may record handwritten notes on the sheet layers 30 of the notepad assembly 28. After recording the desired information on the notepad assembly 28, the user may then flip the badge member 12 downwardly against the sheet layers 30 such that the sheet layers 30 are sandwiched and protected between the badge member 12 and the rigid backing 42.

The notepad assembly 28 and badge member 12 form the badge assembly 10 which the user may conveniently carry during daily activities. In this regard, the badge assembly 10 provides a convenient means for carrying the notepad assembly 28 wherein the notepad assembly 28 may be fixedly secured to the badge member 12 by means of a lanyard or strap 26 or other connecting device. Such connecting device may comprise a variety of configuration and may include commonly-used mechanisms for securing employee identification badges to an article of clothing or to an object worn by the user. The notepad assembly 28, in one embodiment, is configured to be secured behind the badge member 12 so that the notepad is out of sight and does not detract from the primary functions of the employee identification badge. Due to its accessibility, the notepad assembly 28 provides a quick and efficient means for taking notes on short notice.

It should be noted that the badge member 12 as described herein is for exemplary purposes only and should not be construed as limiting the different types of objects which may be used in conjunction with the notepad assembly 28. In this regard, the badge member 12 may be described in the context of an employee identification badge which, under industry standards, may be configured in a generally rectangular shape having approximate dimensions of 3.37 inches by 2.25 inches although the badge member 12 may be provided in any size, shape and configuration. The badge member 12 may further include a rounded slot, cutout or opening 20 having a standard measure of approximately 0.12 inches by 0.050 inches although other sizes are contemplated. The cutout may be positioned approximately 0.19 inches from an edge of the badge member 12 such as from a top edge thereof.

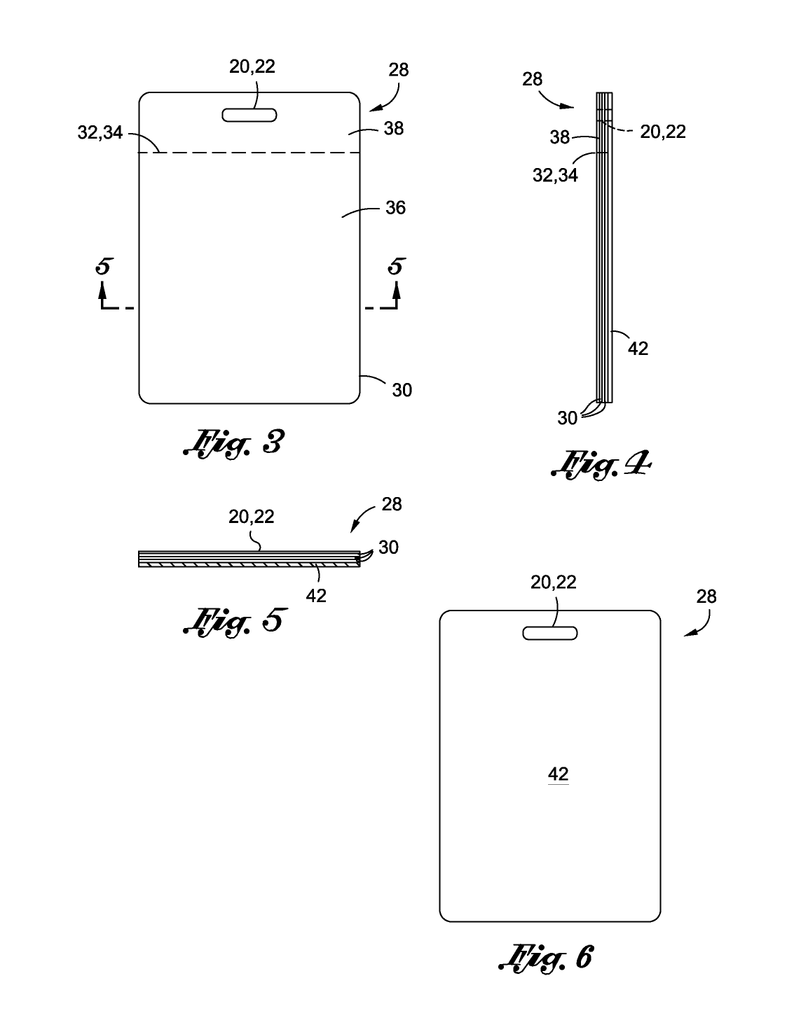

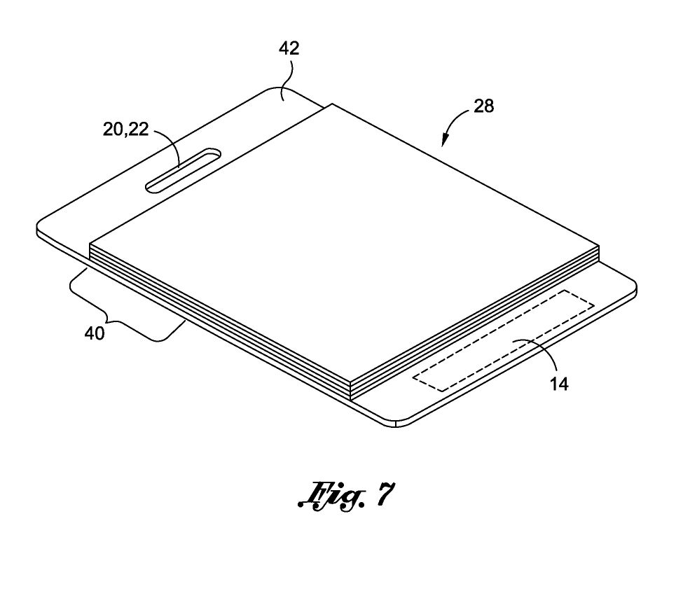

Referring to FIGS. 2-6, shown is the notepad assembly 28 comprising the rigid backing 42 and at least one and, more preferably, a plurality of sheet layers 30 arranged in stacked formation. As can be seen, the rigid backing 42 preferably comprises an elongate material which is sized complementary to the badge member 12 to which it may be secured. However, it is also contemplated that the rigid backing 42 may be provided in a shape that is dissimilar or different from that of the badge member 12. As was earlier mentioned, the rigid backing 42 preferably functions as a clip board and provides a stable and rigid surface against which the notepad assembly 28 may be secured to allow the user to record handwritten notes, sketches, diagrams, illustrations and other information. Furthermore, the notepad assembly 28 may be configured to receive various objects such as stickers, tags and other items which the user desires to carry without having to place such items in a separate location such as in the user's pockets or in a separate notebook or another carrying device.

In the embodiments illustrated, the rigid backing 42 is preferably constructed of a relatively stiff material and may be provided in any size and shape. The rigid material is preferably a plastic material although various other metallic and non-metallic materials may be used. For example, the rigid backing 42 may be constructed of aluminum and/or steel. Furthermore, the rigid backing 42 may be fabricated of other materials including, but not limited to, tempered hardwood, wood, glass, mica, hardboard, paper, ceramic, stone, porcelain, composite material such as fiberglass or carbon fiber or any other composition or combination thereof.

The rigid backing 42 is preferably shaped complementary to the shape of the badge member 12 although the rigid backing 42 may be provided in any alternative size and shape. If provided in a configuration which is complementary to an industry standard employee identification badge, the rigid backing 42 may comprise a rectangular shape having rounded corners and having a size measuring approximately 3.37 inches by 2.13 inches as was indicated above.

As shown in the Figures, the rigid backing 42 and badge member 12 may preferably include at least one opening 20 which is shown as a slot 22 formed along an upper edge of the rigid backing 42 and badge member 12. The opening 20 is preferably configured as a slot 22 having rounded ends and measuring approximately 0.13 inches by 0.5 inches although other sizes and shapes are contemplated. The opening 20 or slot 22 formed in the rigid backing 42 is preferably positioned complementary to the position of the slot 22 in the badge member 12 such that the outer perimeters of the rigid backing 42 and the badge member 12 are aligned when connected together. As was earlier mentioned, the connecting device 24 may comprise a strap 26 which is extendable through the openings (e.g., slot) of the badge member 12 and rigid backing 42. In this regard, the slot 22 may be positioned such that the longer sides of the slot 22 are oriented parallel relative to a top side of the rigid backing 42 which, in the Figures illustrated, is a short side of the rigid backing 42.

The opening 20 or slot 22 is preferably centered at the top of the backing and aligned with the opening 20 or slot 22 formed in the badge member 12. However, it should be noted that the opening 20 may be sized and shaped in any configuration and may be positioned and oriented in any manner other than that which is shown in the Figures. However, in the embodiment shown, the slot 22 is preferably located approximately 0.19 inches from the edge of the rigid backing 42 which is complementary to the dimensions of the badge member 12. Furthermore, although shown as being oriented to be worn in a portrait orientation, it should be noted that the badge member 12 and the rigid backing 42 may be oriented in a landscape orientation wherein the long sides of the rigid backing 42 are disposed along the upper and lower edges of the rigid backing 42.

As can be seen in FIG. 1, the outer surfaces of the badge member 12 may include multiple portions or areas wherein different markings and/or wherein images may be placed. For example, as shown in FIG. 1, the badge member 12 may include an alphanumeric 16 identification section which may include, for example, an employee identification number. In addition, the badge member 12 may include a department number and other markings and indicia 14. As is common in the industry, the employee identification badge may further include an image 18 such as a photograph, rendering, logo or other image 18 which may identify the user, a department or an organization that the user represents.

Referring still to FIGS. 2-6, shown is the notepad assembly 28 which includes the plurality of sheet layers 30 shown formed in the stacked arrangement. As can be seen, the notepad assembly 28 is shown as being sized, shaped and configured complementary to the size, shape and configuration of the rigid backing 42. In this regard, the sheet layers 30 which make up the notepad assembly 28 may each include an opening 20 or slot 22 which is complementary to the opening 20 or slot 22 formed in the rigid backing 42 and the badge member 12. However, it is contemplated that the sheet layers 30 may be formed of a size that is smaller or larger than the overall size of the rigid backing 42.

Referring briefly to FIG. 7, shown are the sheet layers 30 being sized and positioned such that the upper edge of the sheet layers 30 are disposed in spaced arrangement to the slot. In this regard, the sheet layers 30 themselves may not include an opening 20 or slot. In addition, although the sheet layers 30 are illustrated as extending downwardly to the lower edge of the rigid backing 42, it is contemplated that the bottom edge of the sheet layers 30 are disposed in spaced relation to the bottom edge of the rigid backing 42. In the exemplary embodiment illustrated in FIG. 7, the sheet layers 30 are shown disposed in stacked arrangement and having a length or height which is relatively short compared to the overall height of the rigid backing 42. The sheet layers 30 in FIG. 7 are also illustrated as having a width that is complementary or substantially equivalent to a width of the rigid backing 42 although other relative widths may be used.

The sheet layers 30 which make up the notepad assembly 28 may be constructed of any material capable of receiving information or notes such as handwritten notes. The sheet layers 30 may be constructed of a variety of different materials such as ground wood paper, free sheet paper, plastics, ceramic materials, metallic and non-metallic materials and any other material types or combinations thereof. The sheet layers 30 are preferably adapted to receive information using any type of implement such as conventional writing implements including pens, pencils, markers or other conventional implements in addition to non-conventional implements capable of forming writings, sketches, drawings, diagrams, markings and any other type of information. The sheet layers 30 may be formed of materials that may be adapted to receive self-adhesive 40 items including, but not limited to, stickers, tags, and other objects which may be applied to the sheet layer 30 for referral or retrieval at a later time.

Although a stack of the sheet layers 30 may be provided in any overall thickness, a preferred combined thickness of the sheet layer 30 stack may range from approximately 0.050 inches to approximately 0.100 inches. Furthermore, although the sheet layers 30 may comprise a stack of sheet layers 30 of any quantity, a preferable range of sheet layers 30 in the stacked arrangement ranges from ten (10) sheet layers 30 to approximately fifty (50) sheet layers 30. Each individual sheet layer 30 may be provided in any thickness although a preferable thickness range is from approximately 0.0015 inches to approximately 0.0050 inches.

Although provided in the portrait configuration as described above with reference to the rigid backing 42, the individual sheet layers 30 of the notepad assembly 28 may be provided in a variety of orientations such as in the landscape orientation discussed above. If provided in a rectangular shape having rounded corners, each sheet layers 30 of the notepad assembly 28 preferably measures 3.37 inches by approximately 2.13 inches which is in keeping with the industry standard for identification badges as discussed previously. Ideally, the individual sheet layers 30 of the notepad assembly 28 are preferably complementary to the size, shape and configuration of the rigid backing 42 and the badge member 12.

The opening 20 or slot 22 which is preferably formed in the rigid backing 42 may also be formed in the individual sheet layers 30 of the notepad assembly 28. As such, the opening 20 or slot 22 formed in the sheet layers 30 is preferably formed complementary to the opening 20 or slot 22 formed in the rigid backing 42. Likewise, the spacing between the top of the slot 22 and the top of the rigid backing 42 is preferably complementary to that of the individual sheet layers 30.

Each of the sheet layers 30 is preferably affixed to an adjacent one of the sheet layers 30 along at least one edge of the sheet layer 30. Each of the sheet layers 30 may be affixed using various materials including, but not limited to, adhesive 40, double sided tape, paste, glue, gum, cement, epoxy resin and a variety of chemical fastening means. In addition, the sheet layers 30 may be affixed to one another using mechanical means such as staples, clips, brackets, rivets and a variety of other mechanical means. Furthermore, each of the sheet layers 30 may be affixed by a combination of mechanical and non-mechanical means. In one embodiment, the individual sheet layers 30 may be releasably and adhesively 40 attachable to one another in an arrangement similar to the configuration of commercially available self-stick notepads.

Alternatively as shown in FIGS. 2-6, the sheet layers 30 may each be provided with a separation joint 32 such as a perforation line 34 extending along the sheet layer 30 and from which a removable portion 36 of each sheet layer 30 is detachable from a fixed portion 38 of the sheet layer. In this regard, the fixed portion 38 of the sheet layer 30 represents that portion which is disposed above the separation joint 32 or perforation line 34. However, in an alternative embodiment, each sheet layer 30 may be releasably adhered to the rigid backing 42 and to one another along the upper portion of the sheet layers 30 similar to the self-stick adhesive notepads.

For the configuration of the sheet layers 30 having the perforation line 34, a user may remove each sheet layer 30 by tearing along the perforation line 34 or by first folding and then tearing along the perforation line 34. In a preferred embodiment, the perforation line 34 may extend linearly across the upper portion of the sheet layer 30 and may be positioned approximately 0.5 inches from an upper edge of the sheet layer. Although formed as a series of dots or dashes running linearly width-wise across the sheet layers 30, it is also contemplated that the perforation line 34 may be performed in non-linear arrangements such as a curved arrangement, a zigzag arrangement or a variety of other arrangements.

For the embodiment shown in FIGS. 2-6, the individual sheet layers 30 may be separately formed from the rigid backing 42 or may not be attached thereto by permanent means. For example, the rigid backing 42 may be provided as separate sheet layers 30 which are secured to the rigid backing 42 and to the badge member 12 by means of the connecting device 24 such as a strap 26 which may be extended through the slot 22 formed in the rigid backing 42, sheet layers 30 and badge member 12. In this arrangement, the individual sheet layers 30 and the rigid backing 42 may not be affixed to one another and may instead be held together by the strap. However, because the sheet layers 30 are sandwiched between the rigid backing 42 and the badge member 12, the sheet layers 30 are protected from tears, bends and curled corners similar to the manner in which a hardcover book protects interior pages. Furthermore, the rigid backing 42 and/or the badge member 12 may protect the individual sheet layers 30 from dirt, debris and exposure to the elements such as sunlight, fog, rain and other forms of moisture which may detrimentally affect the sheet layers 30. In addition, the rigid backing 42 and the badge member 12 may hide information from public view due to the sandwiching of the individual sheet layers 30 between the badge member 12 and the rigid backing 42.

The badge assembly 10 may further comprise the connecting device 24 which is preferably configured to connect the rigid backing 42 to the badge member 12 and/or to the sheet layers 30. The connecting device 24 is also preferably configured to allow pivoting or rotating the badge member 12 upwardly and away from the notepad assembly 28 to expose the outermost sheet layer. Toward this end, the connecting device 24 may be configured in a variety of configurations in addition to the strap 26 configuration shown in the Figures. For example, the connecting device 24 may be configured as a split key ring, swivel hook, plastic hook, lanyard attachment, wristband attachment, bulldog clip or any other suitable device for releasably connecting the badge member 12 to the rigid backing 42 and/or to the sheet layers 30. Assembly of the badge assembly 10 may be facilitated by extending the connecting device 24 such as the strap 26 through the opening 20 which may be formed as a slot 22 as illustrated in the Figures. The connecting device 24 (i.e., strap) is preferably configured to fixedly hold the badge member 12 and the notepad assembly 28 into position relative to one another.

During use of the notepad assembly 28, a user having a badge member 12 such as an employee identification badge may attach the notepad assembly 28 to the badge assembly 10 by first unlatching the existing strap 26 and removing the employee badge therefrom. The user may then position the backside of the badge member 12 over a frontside of the notepad assembly 28 such that the opening (i.e., slot) in the notepad assembly 28 is aligned with the opening 20 of the badge member 12. The user may then re-insert the strap 26 through the opening 20 (i.e., slots) of the badge member 12 and the rigid backing 42 and/or sheet layers 30. The user may then latch the strap 26 such that the identification indicia 14 (e.g., employee name) and image 18 (e.g., photograph) are exposed to public while the notepad assembly 28 is positioned out of sight behind the badge member 12.

Referring briefly to the configuration illustrated in FIG. 7, the notepad assembly 28 may comprise the sheet layers 30 which may be configured as self-stick adhesive layers and which may comprise a commercially-available self-stick notepad. A lowermost sheet layer 30 of the notepad assembly 28 may be adhered to the rigid backing 42 or badge member 12 using an adhesive 40 having a relatively high strength such that removal of uppermost sheet layer 30 will not result in removal of the entire stack of sheet layers 30 or removal of individual sheet layers 30 stacked below. In addition, the adhesive 40 may be configured as a permanent and/or semi-permanent adhesive 40. Furthermore, in a preferable embodiment, the sheet layers 30 may be sized and configured to allow exposure of a lower portion of the rigid backing 42 such that various indicia 14 or markings may be provided thereon. For example, a company logo or promotional marking may be placed in the noted area.

The individual sheet layers 30 may be affixed at any location on the rigid backing 42 and are not limited to the aligned position shown. The sheet layers 30 may be directly affixed to a backside of the badge member 12 and/or to any other device that may be suspended from the strap. The notepad assembly 28 may be secured to the badge member 12 using any method such as paste, glue, tacky substance, gum, cement, epoxy resin or any other suitable adhesive 40 as well as any suitable mechanical means including, without limitation, staples, clips, brackets, and/or any other features.

Furthermore, as was earlier mentioned, the individual sheet layers 30 may be affixed to one another using a variety of different materials such as adhesives 40 in various forms as well as with various mechanical fastening systems. In addition, the sheet layers 30 may be affixed to one another along the perimeter edges thereof using a flexible substrate or membrane extending along a length of the edges of a stack of sheet layers 30 in order to bind the sheet layers 30 together. In this regard, the sheet layers 30 may be bound to one another and/or to the rigid backing 42 using any suitable means. Furthermore, the means for securing the individual sheet layers 30 to one another may be temporary and are not limited to permanent attachment such that a user may remove one or more sheet layers 30 from the notepad assembly 28 without damaging the sheet layer 30 behind it. However, the sheet layers 30 may be permanently secured to the notepad assembly 28 and/or to other sheet layers 30.

As was earlier mentioned, the rigid backing 42 and/or sheet layers 30 may be provided in any size, shape or configuration and are not limited to the rectangular shape shown in the Figures. For example, the notepad assembly 28 and/or sheet layers 30 may be provided as an oval, circle, triangle, square, trapezoid, diamond, heart, moon, half circle or any other variety of multi-sided shapes including stars, octagons, hexagons, and pentagons or any other polygonal shape. Furthermore, the sheet layers 30 and/or rigid backing 42 may be provided in any color or the sheet layers 30 and/or rigid backing 42 may be provide in a non-colored version. In addition, the sheet layers 30 and/or rigid backing 42 may be provided in a single color or in multiple colors and/or combinations thereof.

The opening 20 and/or slot 22 formed in the rigid backing 42 and/or sheet layers 30 may be positioned anywhere and is not limited to the center position shown in the Figures. For example, the opening 20 or slot 22 in the rigid backing 42 and/or sheet layers 30 may be positioned so that the rigid backing 42 and sheet layers 30 are in misalignment with one another. Furthermore, the rigid backing 42 and/or sheet layers 30 may be fabricated without an opening 20 or slot 22.

As was earlier indicated, the notepad assembly 28 may comprise any number of sheet layers 30 and in any thickness and is not limited to the sizes previously described. The separation joint 32 such as the perforation line 34 mentioned above may be positioned anywhere on the notepad assembly 28 and/or may be aligned or positioned in any orientation. The perforation line 34 may extend from one end of the sheet layer 30 to an opposite end of the sheet layer 30 in any configuration other than a linear configuration and may include a curved, scribbled, freeform and/or jagged line configuration.

Regarding the connection between adjacent sheet layers 30, such connection may be at any location and in any pattern and is not solely limited to an upper end of each of the sheet layers 30 as illustrated in the Figures. Each of the individual sheet layers 30 of the notepad assembly 28 may be blank or may include printed designs and/or text or any image. Such image or text may include lines, signs, company logos, names of a business, personal names, personal information, pictures and/or special documents such as a document prescription pad.

Each of the sheet layers 30 of the notepad assembly 28 may incorporate any type of texture which may be a rough or smooth surface texture and/or which may be impressed with a design. A rough or smooth texture may be the result of the type of material or paper which is used to manufacture the sheet layers 30. In addition, the sheet layers 30 may include raised surfaces formed by a stamped pattern using any instrument such as an engraving tool or a die or mold. Such instrument may impress such pages of the sheet layers 30 leaving a textured pattern or mark. Such markings may be provided on any page or on random pages and in a particular pattern.

In a further embodiment, the badge assembly 10 may include a writing implement such as a tool or a writing device such as a pen, pencil, or other writing instrument. Furthermore, such badge assembly 10 may include provisions for mounting various tools including, but not limited to, tweezers, pliers, a time piece, a magnifier, an illuminator or similar devices which may be attached to the badge assembly 10 by any means including, but not limited to, clips, holsters, Velcro and any other mechanical or non-mechanical means including adhesive 40.

Although preferably constructed of rigid material, the rigid backing 42 and/or the badge member 12 may be fabricated to allow bending or flexing or bowing of the entire badge assembly 10. In a preferable embodiment, the badge assembly 10 is preferably installed such that the badge member 12 is located in front of the notepad assembly 28. The openings or slots are preferably aligned to allow a user to thread a connecting device 24 such as a badge strap 26 through the slot 22 or opening. If other items are suspended from a badge strap 26 in addition to the badge member 12, the badge assembly 10 may be installed in front of or behind these additional devices or items such that the opening 20 or slots thereof are aligned to allow a user to thread the connecting device 24 such as a strap 26 through such devices.

The other items that may be suspended from the strap 26 in addition to the badge member 12 may include, without limitation, blank cards, printed cards, photographs and any other item. The badge assembly 10 may be installed backwards meaning that the user may unlatch the existing badge member 12 and remove and position the badge member 12 behind the notepad assembly 28 such that the openings 20 or slots 22 thereof align with one another. The user may then re-insert the strap 26 through the opening 20 or slot 22 formed in the badge member 12 and the slot 22 formed in the rigid backing 42 and/or sheet layers 30. The user may then latch close the strap 26 to prevent loss of the badge member 12 and/or notepad assembly 28.

The above description is given by way of example and not limitation. Given the above disclosure, one skilled in the art could devise variations that are within the scope and spirit of the embodiments disclosed herein. Furthermore, the various features of the embodiments disclosed herein can be used alone or in any varying combinations with each other and are not intended to be limited to the specific combinations described herein. Thus, the scope of the claims is not to be limited by the illustrated embodiments.

What is claimed is:

1. A badge assembly comprising:
a badge member;
a rigid backing attachable to the badge member; and
at least one sheet layer attachable to at least one of the rigid backing and the badge member;
wherein at least one of the rigid backing and the badge member is configured to pivot away from the sheet layer.

2. The badge assembly of claim 1 further comprising:
a connecting device configured to connect the rigid backing to the badge member.

3. The badge assembly of claim 2 wherein:
the badge member and the rigid backing each include at least one opening formed therein;
the connecting device being configured to be extended through the opening in the badge member and the rigid backing.

4. The badge assembly of claim 2 wherein:
the connecting device is a strap.

5. The badge assembly of claim 2 wherein:
the connecting device is configured to allow the badge member to be pivoted away from the sheet layer.

6. The badge assembly of claim 1 wherein:
the sheet layer is removably attachable to at least one of the badge member and the rigid backing.

7. The badge assembly of claim 1 wherein:
the sheet layer is releasably adhered to the rigid backing.

8. The badge assembly of claim 1 wherein:
the sheet layer comprises a plurality of sheet layers arranged in a stacked formation.

9. The badge assembly of claim 1 wherein:
the sheet layer includes a separation joint along which a removable portion of the sheet layer is detachable from a fixed portion thereof.

10. The badge assembly of claim 9 wherein:
the separation joint comprises a perforation line.

11. A notepad assembly for a badge assembly, comprising:
a rigid backing; and
at least one sheet layer;
wherein the notepad assembly is adapted to be secured to the badge assembly.

12. The notepad assembly of claim 11 further comprising:
a connecting device;
wherein:
the rigid backing is adapted to be attached to a badge member having an opening formed therein;
the rigid backing including an opening formed complementary to the opening in the badge member;
the rigid backing being configured to be attachable to the badge member with the connecting device configured to be extended through the opening in the badge member and the rigid backing.

13. The notepad assembly of claim 12 wherein:
the connecting device is a strap.

14. The notepad assembly of claim 11 wherein:
the opening in the badge member and the rigid backing being configured to allow the badge member to be pivoted away from the notepad assembly to expose the sheet layer.

15. The notepad assembly of claim 11 wherein:
the sheet layer includes a separation joint along which a removable portion of the sheet layer is detachable from a fixed portion thereof.

16. The notepad assembly of claim 15 wherein:
the separation joint comprises a perforation line.

17. The notepad assembly of claim 11 wherein:
the sheet layer is releasably adhered to the rigid backing.

18. The notepad assembly of claim 11 wherein:
the sheet layer comprises a plurality of sheet layers arranged in a stacked formation.

19. A notepad assembly for a badge member configured as an identification badge having a substantially thin rectangular shape, the notepad assembly comprising:
a rigid backing pivotally connectable to the badge member and being sized and configured complementary thereto;
a plurality of sheet layers releasably adhesively attachable to the rigid backing and being disposable between the rigid backing and the badge member; and
a connecting device configured to connect the rigid backing to the badge member;
wherein at least one of the rigid backing and the badge member is configured to be pivoted away from the sheet layers to at least partially expose the sheet layers;
the rigid backing and badge member being of substantially equal length and width and having a substantially similar shape.
